(19) United States
(12) Patent Application Publication
(10) Pub. No.: US 2008/0236500 A1
(43) Pub. Date: Oct. 2, 2008

(54) APPARATUS, SYSTEM, AND METHOD FOR ANIMAL MONITOR

(76) Inventors: Terry E. Hodges, Logan, UT (US); Todd L. Hodges, North Bridge, MA (US)

Correspondence Address: Kunzler & McKenzie, 8 EAST BROADWAY, SUITE 600, SALT LAKE CITY, UT, 84111, US

(21) Appl. No.: 12/034,611

(22) Filed: Feb. 20, 2008

Related U.S. Application Data
(60) Provisional application No. 60/890,804, filed on Feb. 20, 2007.

(51) Int. Cl. A01J 5/00; A61D 99/00; G08B 23/00

(52) U.S. Cl. 119/14.02; 600/301; 600/302; 340/573.3

(57) ABSTRACT

An apparatus, system, and method enable monitoring of one or more physiological conditions in an animal including pH. A monitor may take the form of a bolus that may be installed in a stomach of an animal such as in a reticulorumen of a ruminant animal. The monitor may include sensors for detecting one or more of the pH, temperature, pressure, and position. The monitor includes a power source and electronics for processing, storing, and transmitting signals representing the physiological conditions detected by the sensor(s). The monitor may include first and second portions that are releasably joined, and that may support respective components for ease of assembly during manufacture and servicing. The monitor may form part of a system having a receiver for receiving and interpreting the signals from the monitor. The method includes installing the monitor in an animal and monitoring the animal by detecting physiological characteristics.

### BACKGROUND OF THE INVENTION

1. Field of the Invention

This invention relates to a system of monitoring and for domestic and game animals and more particularly relates to an internal monitoring and transmitting system for ruminant livestock.

2. Description of the Related Art

Livestock producers face a need to reliably identify each animal in the herd and to monitor the location and physiological condition of the animal. Physiological condition not only determines the survival of the animal but also impacts other factors including weight gain, meat production, milk production, and the safety of animal products for human consumption. Concerns with mad cow disease and other conditions communicable to humans have intensified the concern and the need for practical, reliable, animal monitoring.

The current state of the art reflects a number of attempts to address these concerns. Traditional solutions have included tracking animals with brands and ear tags. Brands, however, are limited to herd, rather than individual identification, and ear tags have proven unreliable because they are easily lost, removed, or altered. A more reliable approach has been an insoluble bolus configured to reside within the rumen of a ruminant animal such as a bovine, sheep, goat, or deer. A small device does not interfere with the rumen function and a sufficiently heavy device is not regurgitated.

Because free grazing animals sometimes ingest wire and other hardware a magnet is also often placed in the rumen to capture metal objects and prevent then from inflicting damage as they move through the digestive system. Some devices incorporate magnets to collect ingested hardware and some are designed to coexist in the rumen with a magnet. At least one device employs a bioactive coating that bonds to soft tissue in order to keep the bolus in the rumen.

Typically, the bolus includes a transmitter that sends a signal upon interrogation or a pre-set schedule

Alternative methods of accessing and/or monitoring the contents of the rumen include a permanent fistula directly into the rumen, an oral/gastric tube, and withdrawing rumen fluid with a syringe. These methods are cumbersome, time-consuming, and traumatic for the animal.

Prompt location of an identified animal is desirable for accounting purposes and to administer timely treatment to an ill or injured individual. A method of doing so with the use of a bolus would be desirable.

### SUMMARY OF THE INVENTION

Notwithstanding the advances in tracking animals and monitoring health of animals, there exist many unresolved problems and ongoing needs in the art of tracking and monitoring animals. For example, devices of the past suffer from limited battery life and limited range of signal transmission, which present continuing challenges. Additionally, while it is desirable to monitor a number of functions in addition to identity and location, using too many separate devices for monitoring these various functions can over-crowd the rumen. Therefore, there is a need for a combination device having several sensors and/or other detectors for performing several respective functions as well as identification and tracking mechanisms in a single monitoring device.

Because the art of the past does not include a device in the form of a bolus that can send a signal for a considerable distance, is inexpensive to manufacture, and is reusable, there is a need for a device that has these advantages. Such a device that combines all of the desirable functions within one compact unit does not appear to be available, and is greatly needed.

From the foregoing discussion, it should be apparent that a need exists for a compact, reliable, reusable apparatus, system, and method that combines the functions of animal identification, location, and physiological monitoring, and which can also transmit a signal over long distances. Beneficially, such an apparatus, system, and method would be inexpensive to manufacture and easy to recover and reprogram for reuse.

The present invention has been developed in response to the present state of the art, and in particular, in response to the problems and needs in the art that have not yet been fully solved by currently available animal monitoring devices. Accordingly, the present invention has been developed to provide an apparatus, system, and method for monitoring an animal and that overcome many or all of the above-discussed shortcomings in the art. In particular, embodiments of the present invention have been developed to address tracking of animals and monitoring health concerns in the mass-production livestock and dairy industries including bovine respiratory syndrome, mastitis, and mad cow disease. In one aspect, embodiments of the invention include internal and/or external monitoring and transmitting systems and devices for ruminant livestock. In some embodiments, a device resides in the reticulorumen of the animal. In other embodiments, a device is connected to a milking machine.

For example, in one embodiment, a bolus shaped monitor is provided of sufficient density to be retained in the rumen of a ruminant animal. The monitor body is composed of non-magnetic material and has a short cap containing sensing components and a long barrel containing a circuit board with electrical components and a weighted power source. In one embodiment the monitor body assumes a cylindrical form with rounded ends. The short cap, with its sensing components, may be removably attached to the long barrel using a pressure fit, mated threads, a snap cap, a friction seal or the like.

The sensing components contained in the short cap may include a temperature sensor, a pressure sensor and a pH sensor. In one embodiment the pH sensor is an ion sensitive field effect transistor (ISFET). The pressure sensor may be a commercially available pressure chip.

The monitor may also contain various combinations of an identification device, a data retention component such as a memory chip, an antenna, a receiver, a signal transmitter, and a logic chip configured to compare a sensor reading to a standard. In a further embodiment the monitor may contain a position locator such as an RFID chip. The logic and data retention components may be re-programmed upon recovery of the bolus to allow for reuse.

A system of the present invention is also presented to monitor an animal. The system may be embodied in a combination of the monitor, including the sensors and transmitter, and a receiver. In particular, the system, in one embodiment, includes a regurgitation-resistant, non-magnetic monitor comprising a short cap and long barrel. The short cap may contain sensing components including a pH sensor, pressure sensor, temperature sensor and the like. The pH sensor may be a purchased device such as an ISFET. In a further embodiment the long barrel may contain some combination of the electronics for the sensing devices, an identification device, a programmable memory chip, a receiver, a transmitter, an antenna, and a logic chip configured to compare a sensor reading to a pre-programmed standard. In a further embodiment the electrical components may be mounted on a circuit board. The antenna may be shielded from the electronics by a non-conductive barrier. The long barrel may also contain a weighted power source. The system may further include a receiver and a data recorder. A further embodiment may also include a position locator such as an RFID chip.

Various embodiments of the system may also include a pH sensor such as a ISFET on an animal contact channel of a milking machine and a logic chip configured to compare a sensor reading to a standard pH. The system may further include an alarm signal configured to communicate an abnormal reading.

A method of the present invention is also presented for an animal monitor. The method in the disclosed embodiments substantially includes steps that may be used to carry out the functions presented above with respect to the operation of the described apparatus and system. In one embodiment, the method includes providing a regurgitation-resistant, non-magnetic animal monitor having a cap and a barrel of substantially greater length than the cap and installing the monitor in a ruminant animal. In such an embodiment the monitor communicates animal identity and to senses the pH of an animal rumen contents.

The method may also include providing sensors to monitor other physiological conditions such as temperature and pressure. As such, embodiments of the method include monitoring temperature and monitoring pressure. In an additional embodiment a location sensor such as an RFID chip may be provided for locating an animal.

A further embodiment may include providing a transmitter and a receiver configured to recognize and interpret the transmitted signals. This embodiment may further include transmitting and receiving the signals from the monitor. The method may also include one or more of programming the monitor with pre-set values for pH and other physiological indicators and comparing sensed values with the pre-programmed values such as by a logic chip, for example. Such an embodiment may also include triggering a signal in response to the comparison.

A further embodiment may include treating the animal in response to the signals. The method may also include locating the animal in response to signals from the position locator. Additionally, another embodiment of the method may include recovering the monitor and reprogramming it for reuse once the animal has been harvested.

In another embodiment the method may include providing a pH sensor on the animal contact channel of a milking machine. Such an embodiment may include providing a logic chip configured to compare a pH reading with a pre-programmed pH value and programming the logic chip. This embodiment includes sensing the pH during milking. The method may further include providing an alarm signal to communicate an abnormal reading. In an alternative embodiment the method may include providing a continuous read-out of the pH sensor. The method may also include pulling an animal off of a milking line in response to an abnormal reading and may further include separating the pulled animal's milk from the pool of collected milk. The method may extend to treating the animal pulled off the milking line for an abnormal pH reading.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of an animal monitor in accordance with the present invention;

FIG. 2 is a perspective cut-away view showing a section taken along line 2-2 of FIG. 1 illustrating one embodiment of an animal monitor cap in accordance with the present invention;

FIG. 3A is a schematic view illustrating general contents making up an animal monitor assembly of the animal monitor;

FIG. 3B is a cross sectional view taken along line 3B-3B of FIG. 3A of the animal monitor assembly of FIG. 3A;

FIG. 4 is a schematic view illustrating one embodiment of sensor connections in accordance with the present invention;

FIG. 5 is a schematic view illustrating one embodiment of a circuit board in accordance with the present invention;

FIG. 6 is a schematic view illustrating embodiments of an animal monitoring system in accordance with the present invention;

FIG. 7 is a schematic flow diagram illustrating one embodiment of an animal monitoring method in accordance with the present invention;

FIG. 8 is a flow diagram illustrating one embodiment of an animal pH sensor method in accordance with the present invention;

FIG. 9A is an end view illustrating of one embodiment of a cap for an animal monitor according to the present invention;

FIG. 9B is a side view of the cap taken in the direction of arrow 9B in FIG. 9A;

FIG. 9C is a sectional view taken along line 9C-9C of FIG. 9A;

FIG. 9D is a is a detailed view of a region 9D in FIG. 9C; and

FIG. 9E is a detailed view of a region 9E in FIG. 9C.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, RFID chips, ISFD chips, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

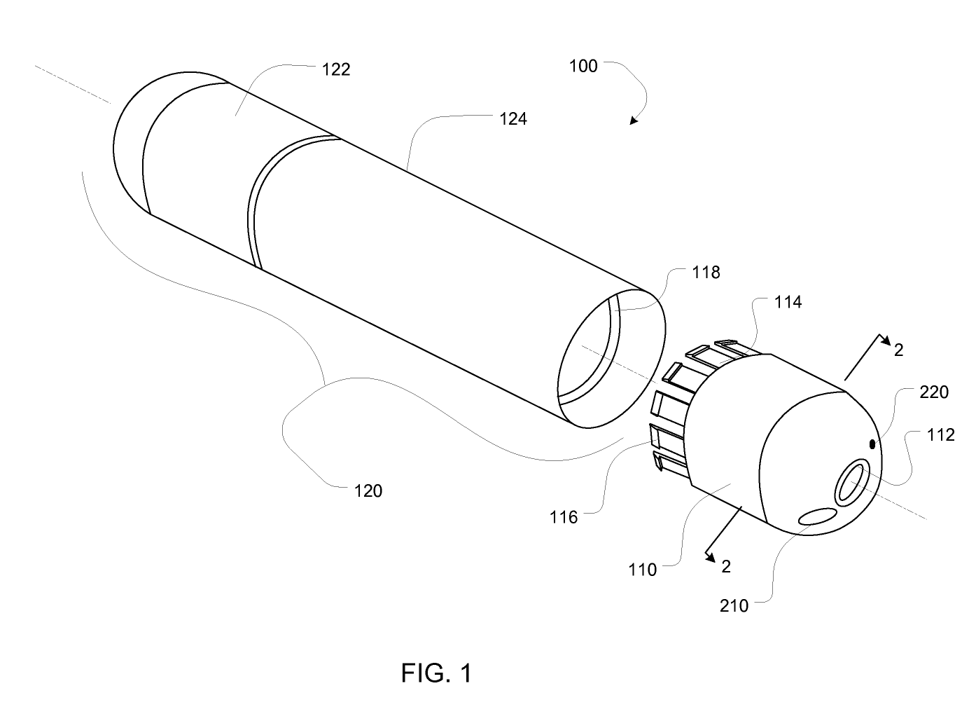

FIG. 1 is a perspective view illustrating one embodiment of an animal monitor 100 in accordance with the present invention. As depicted, the animal monitor 100 comprises a cap 110 and a substantially longer barrel 120 that includes a weighted power module 122 and a processing chamber 124. The cap 110 includes a pressure aperture 112 located, in the illustrated embodiment, in the center of the domed cap. Locking flanges 114 with engagement ridges 116 extend downward from the circumference of the cap. The engagement ridges 116 are configured to snap into a radial or circumferential channel 118 on the inner surface of the barrel 120. In the illustrated embodiment the weighted power module 122 may be removably attached to the monitor barrel 120 by a moisture-tight seal such as a screw, friction fit, or snap fit. In a further embodiment the moisture-tight seal may include an O-ring or other compressible barrier. In a further embodiment the processing chamber 124 and weighted power source 122 may be incorporated into a one-piece monitor barrel.

The animal monitor 100 is composed of a biologically inert non-ferrous and non-magnetic material. When loaded with sensing components in the cap 110 and a circuit board and power source in the barrel 120, the monitor is of sufficient density to be retained in the reticulorumen or rumen of a ruminant animal. The non-ferrous and non-magnetic material will not attract metal items swallowed by the animal and will not adhere to a rumen magnet inserted to collect such items. The monitor may be administered by any of a number of methods known in the art, including a bolus gun. The monitor is typically discharged, along with any other contents of the rumen, when the animal is hung up by the heels following slaughter.

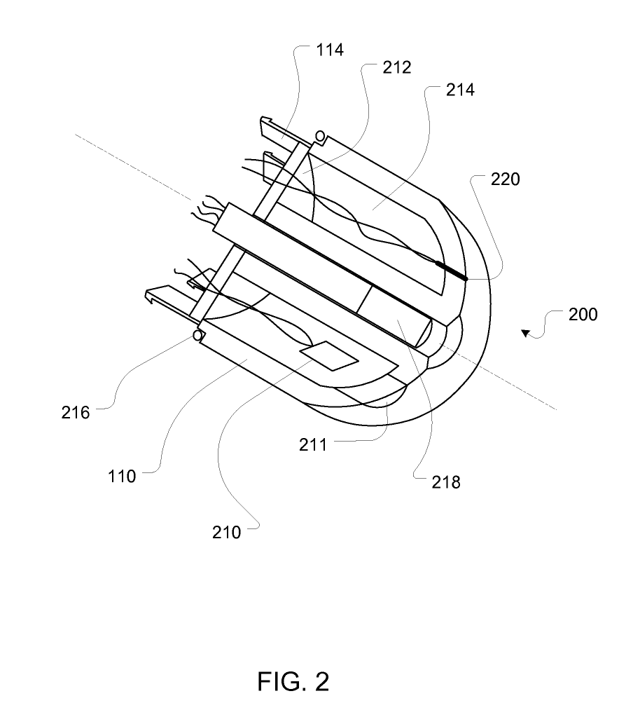

FIG. 2 is a perspective cut-away view illustrating one embodiment of the animal monitor cap 110 for engagement on an upper portion of the barrel 120 in accordance with the present invention. The cut-away extends along a section corresponding to line II-II of FIG. 1 through a center of the monitor 100. As depicted in FIG. 2, the animal monitor cap 110 comprises a domed shell 200, a pressure aperture 112, a pH chamber or channel 210, a cap floor 212, a sensing chamber 214, an O-ring 216, and a pressure sensor 218. A pH sensor 211 such as an ion sensitive field effect transistor (ISFET) may be supported in the sensing chamber 214 and mounted on an interior wall by FDA approved epoxy. A ceramic material or ceramic plug fills an opening through the cap 110 and forms the pH channel 210. The ceramic plug 210 allows passage of ions into and out of the sensing chamber without permitting body fluids or other contaminants to enter an interior of the cap 110. The sensing chamber 214 is filled with a potassium chloride (KCl) or other salt solution that facilitates transfer of ions through the solution to the ISFET sensor. The cap floor 212 is sealed to a main body of the cap 110 and separates the cap 110 with its sensing components from the barrel 120 with its circuit board and power source. Thus, the cap floor and the ceramic plug that fills the pH channel 210 encapsulates the KCl and holds it within the sensing chamber 214. The sensing chamber 214 may also house a temperature 220 or other sensor(s) in a sealed manner that isolates them from the KCl solution. In the illustrated embodiment, the temperature sensor includes a thermocouple sealingly supported in a through opening of the end cap 110. The O-ring 216 provides a water resistant or water-tight seal between the monitor cap 110 and the monitor barrel 120, resisting seepage or substantially excluding rumen fluids and other moisture from the interior of the monitor.

The pressure sensor 218 is supported in a tubular sleeve 222 that isolates the sensor 218 from the sensing chamber 214. The pressure sensor 218 seals the cap 110 against body fluids or other contaminants that may otherwise enter the monitor 100 through the pressure aperture 112. The pressure sensor may be any of a variety of pressure sensors provided by Unisensor of Switzerland, or any other similar sensor that can be supported in the cap 110. The pressure aperture 112 may or may not have an additional sealing diaphragm. However, the pressure sensor is subjected to the pressure in the reticulorumen or whatever environment in which the monitor may reside. Thus, the pressure differentials or pressure changes are sensed and processed.

The separation of the sensors in the monitor cap 110 from the monitor barrel 120 and the easy removal of the monitor cap 110 provides for efficient repair or replacement of any worn or malfunctioning elements or sensors. Wires extend from the various sensors and may be provided with connectors for ease of removal and servicing.

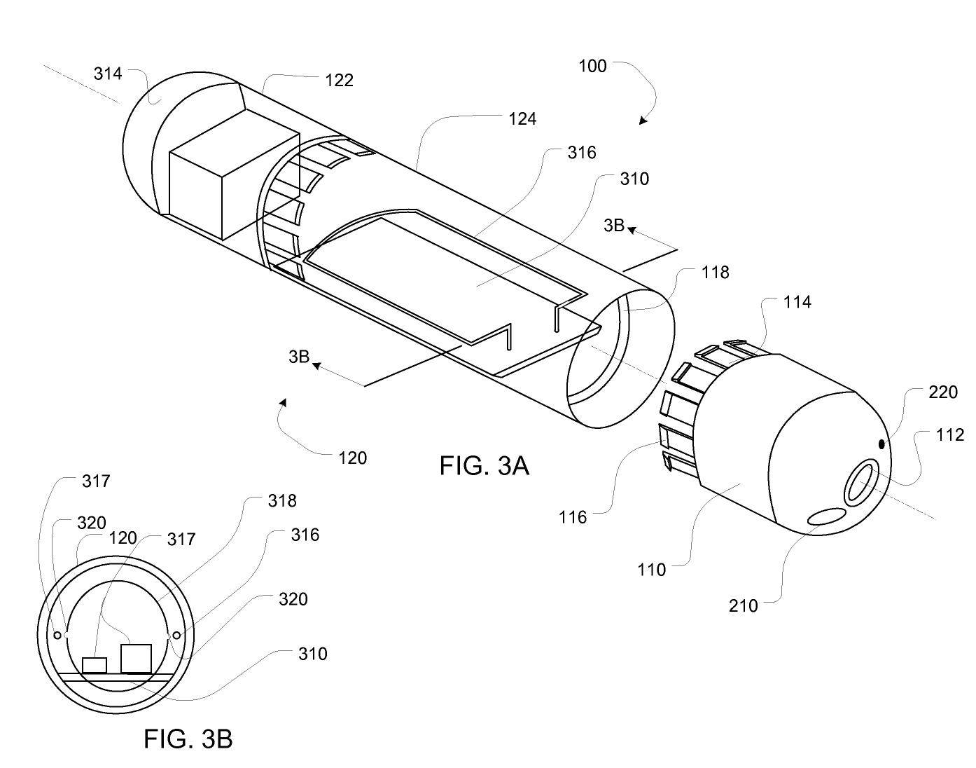

FIG. 3A is a schematic perspective view similar to FIG. 1 illustrating a monitor assembly including an interior in accordance with one embodiment of the animal monitor 100. As depicted, the animal monitor 100 includes a monitor cap 110, a monitor body 120, a weighted power module 122, a processing chamber 124, a circuit board 310, a power source 312, a weight 314, and an antenna 316.

The mass of the weight 314 may vary depending upon the mass of the other components and may be calculated to achieve a total monitor density sufficient to prevent regurgitation of the monitor. In the illustrated embodiment the weight is of a non-magnetic and non-ferrous material, in order to avoid attraction to a rumen magnet or attraction of metal object in the rumen. In one embodiment the antenna extends generally from the monitor cap 110 or top end toward the power module 122 or bottom end of the barrel 120, forms a “U” turn, and extends back toward the cap 110. In further embodiments the antenna 316 may form a series of compact “S” turns or other configurations along the inside of the barrel in order to allow for a longer running length of the antenna 316 or antenna wire. In the illustrated embodiment of FIG. 3A, the antenna 316 resides entirely in the processing chamber 124, facilitating easy removal of the cap 110 and the weighted power source 312. In alternative embodiments the antenna 316 may extend to the distal end of the weighted power module 122 and may be unattached to the wall of the weighted power module 122 or may be easy to disengage in order to allow for removal of the weighted power module 122 from the monitor barrel 120. In one embodiment, an antenna shield 318 is composed of a shielding material and is situated between the circuit board 310 and the antenna 316 in order to shield the antenna from circuit board signals.

As shown in the sectional view taken along line 3B-3B in FIG. 3A, the circuit board 310 houses or supports the monitor electronics 317 including the electrical components of the sensors. The power source 312 supplies power to the monitor 100. In one embodiment the power source 312 is a battery similar to batteries used in pacemakers, or may be an actual pacemaker battery. In a further embodiment the power source 312 may be a battery configured to be charged directly or remotely. The type of battery and the battery life may differ in various embodiments. For example, the typical life span of a meat animal from installation of the monitor to the time of slaughter may be about three months, and the battery may be selected accordingly. The productive life of a dairy animal may be nine months or longer and consequently a dairy animal monitor may be provided with a longer-lived battery. The removable weighted power module 122 allows for easy and efficient battery replacement or recharging, facilitating reuse of the monitor.

FIG. 3B illustrates a cross sectional view of one embodiment of an animal monitor barrel 120. As depicted, the monitor barrel 120 encloses a circuit board 310, an antenna 316, and an antenna shield 318 having perforations 320. The circuit board 310 may have a length that is approximately three fourths a length of the barrel 120. In other embodiments, the circuit board may be at least three-fourths a length of the processing chamber 124. In the illustrated embodiment the antenna shield 318 is composed of a shielding material such as is known in the art and is configured as a cylinder slightly smaller in diameter than the monitor barrel 120. The antenna shield 318 resides inside the monitor barrel 120 and encloses the circuit board 310. The antenna 316 is positioned between the outside wall of the antenna shield 318 and the inside wall of the monitor barrel 120. Perforations 320 in the antenna shield 318 allow the antenna 316 to connect to the circuit board 310 yet extend through the shield 318. Additional perforations may be created in the antenna shield 318 to allow for other connections to the circuit board 310 as necessary. In an alternative embodiment the antenna shield 318 may be of a substantially flat or slightly curved configuration and form a lateral barrier between the circuit board 310 situated in one lateral section of the monitor barrel 120 and the antenna 316 situated in another lateral section of the monitor barrel 120.

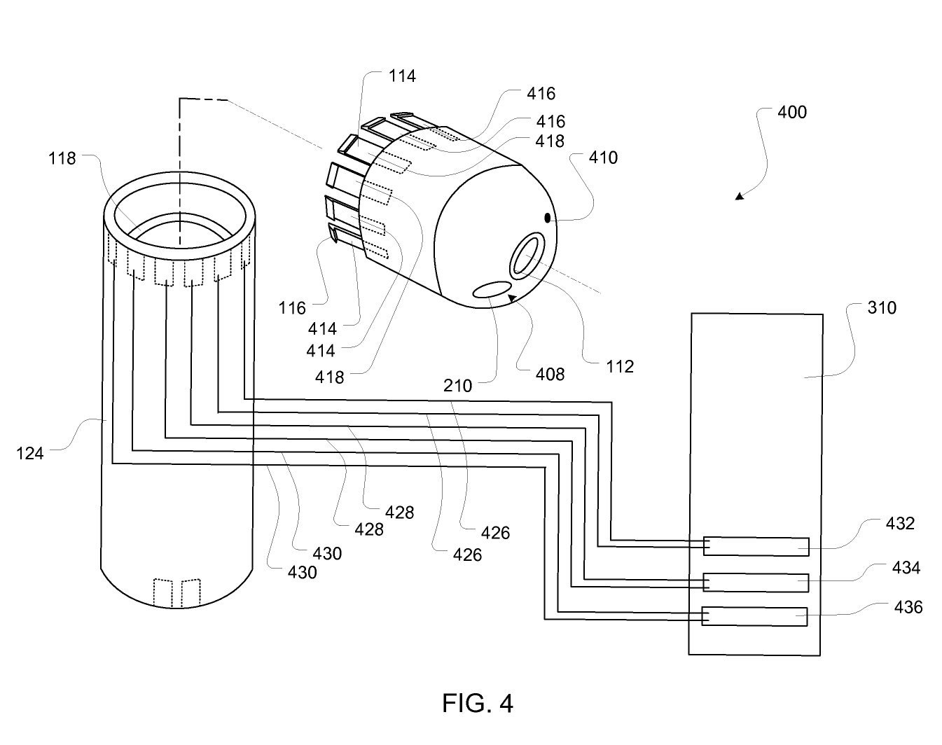

FIG. 4 is a schematic view illustrating one embodiment of a sensor assembly in accordance with the present invention. As depicted, the sensor assembly 400 includes the animal monitor cap 110, the animal monitor barrel 120, the pressure port 112, a pH sensor 408, a temperature sensor 410, a pressure sensor 412, the locking flanges 114, the engagement teeth or ridges 116, cap pH signal or power conducting surfaces 414, cap temperature signal or power conducting surfaces 416, cap pressure signal or power conducting surfaces 418, barrel pH signal or power conducting surfaces 420, barrel temperature signal or power conducting surfaces 422, barrel pressure signal or power conducting surfaces 424, the radial or circumferential channel 118, the circuit board 310, pH sensor connectors 426, temperature sensor connectors 428, pressure sensor connectors 430, a pH module 432, a temperature module 434, a pressure module 436, and power connectors 438 and 440 that may removably connect to respective leads of the power source 312.

The pressure sensor 412 communicates with the rumen fluid via the pressure port 112. In certain embodiments the pressure sensor may be an Attikon Pressure Chip, part number B-06-002. The pH sensor 408 may be inserted in the pH chamber 210 (shown in FIG. 2). In certain embodiments the pH sensor 408 may be an ion sensitive field effect transistor such as an Attikon ISFET Chip, part number B-06-001. The temperature sensor 410 may comprise a thermocouple such as is known in the art.

In the illustrated embodiment the cap signal or power conducting surfaces 414, 416, and 418 receive input from the sensors 408, 410, and 412, and interface with and conduct signals or power to the corresponding barrel signal or power conducting surfaces 420, 422, and 424 when the cap is installed on the barrel. The sensor connectors 426, 428 and 430 conduct the received signals or power to the corresponding module 432, 434, and 436 on the circuit board 310. The removable conducting interfaces of the various signal and power conducting surfaces enable a wire-free detachable interface between the monitor cap 110 and the monitor barrel 120. In alternative embodiments, however, signal bearing wires may replace the signal or power conducting surfaces and interfaces.

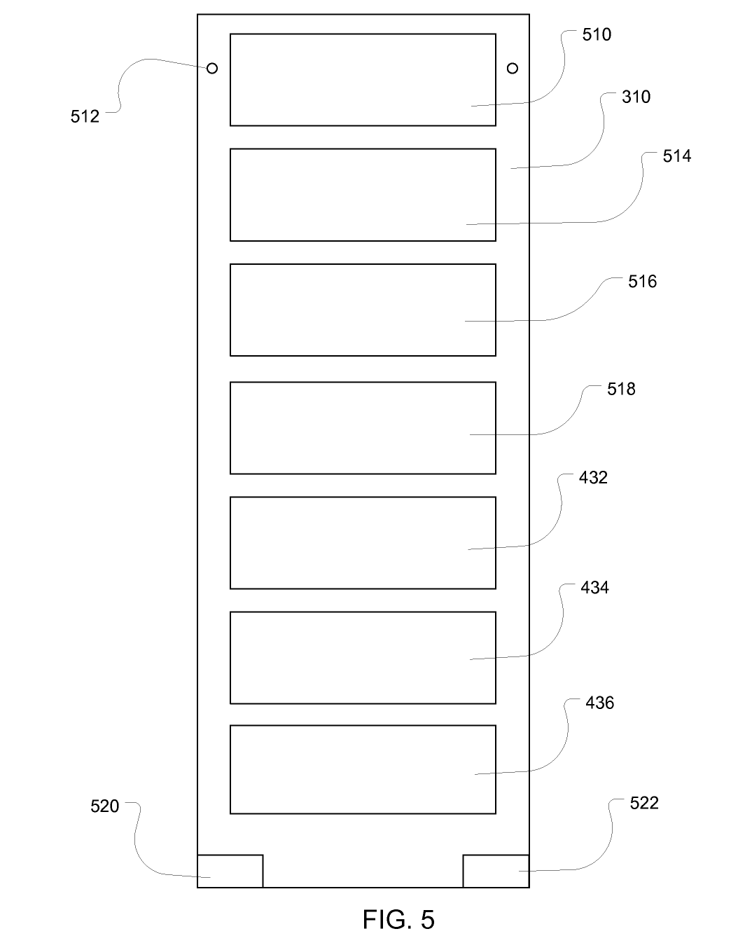

FIG. 5 is a schematic block diagram illustrating the circuit board 310, which may be a more detailed illustration of the same circuit board 310 shown in FIG. 4, in accordance with an embodiment of the present invention. As depicted, the circuit board 310 comprises a communication module 510, antenna connections 512, a memory module 514, a logic module 516, an ID module 518, a pH module 432, a temperature module 434, and a pressure module 436. The ID module 518 may include an RFID chip. Further embodiments may contain various combinations of the foregoing modules and various types of circuit boards such as are known in the art. The antenna 316 connects to the circuit board 310 through the antenna connections 512. The sensor conductors 426, 428, and 430 may connect with the appropriate modules 432, 434, and 436 in a similar fashion. Connection pads 520, 522 may also be connected to the power connectors 438, 440.

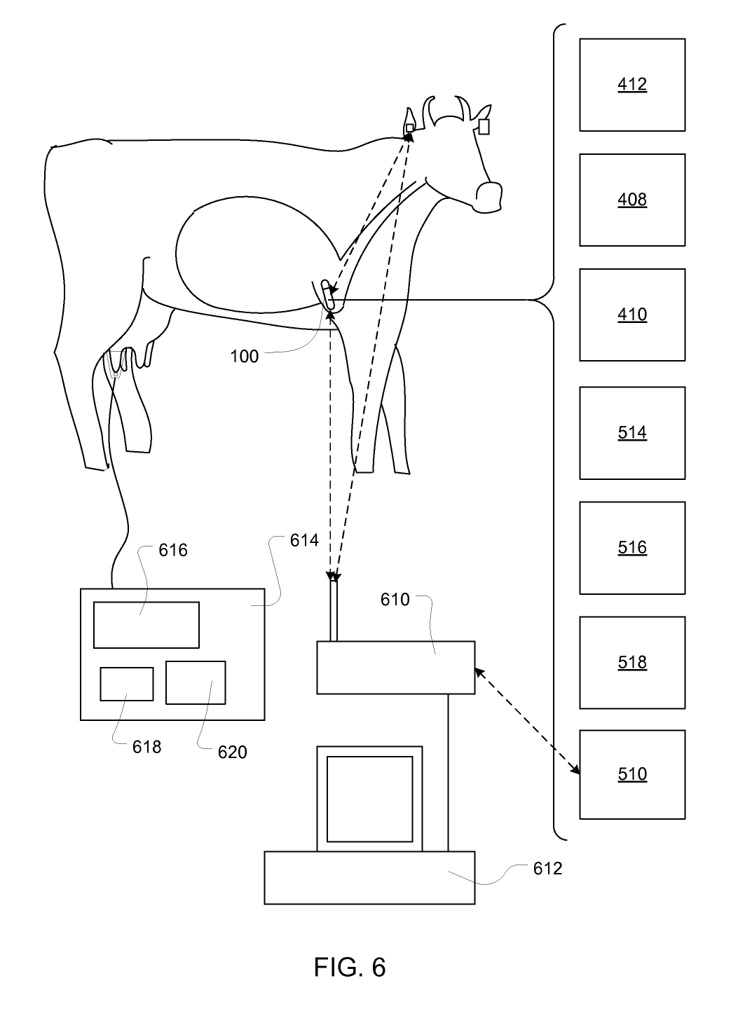

FIG. 6 is a schematic block diagram illustrating one embodiment of an animal monitor system 600 in accordance with the present invention. As depicted, the animal monitor system 600 comprises an animal monitor 100. The animal monitor 100 may include the cap 110 and the barrel 120 shown and described with regard to FIGS. 1-5 above. In various embodiments the cap may enclose any of a variety of combinations of the pressure sensor 412, the pH sensor 408, and the temperature sensor 410. The long barrel 120 may enclose various combinations of the memory module 514, the logic module 516, the ID module 518, and a communication module 510. The illustrated embodiment of the animal monitor system 600 also includes a receiving module 610 and an analysis and programming module 612. It is to be understood that the receiving and/or analysis and programming modules may include one or more hand held or other devices that can be easily used in the field. The receiving module may include both a receiver and a transmitter for receiving signals representing pressure, pH, and temperature, from the pressure sensor 412, pH sensor 408, and the temperature sensor 410 through the communications module 510, and for transmitting signals for programming the animal monitor 100. In this regard, it is to be understood that the signals may be RF or other wireless signals and the connection between the communications module 510 and the receiving module 610 can be an RF or other wireless connection without limitation.

In an alternative or additional embodiment, the animal monitoring system 600 may include a milking machine connection module 614 comprising a pH module 616, a logic module 618, and an alarm module 620. In this embodiment a pH sensor 211, such as an ISFET, may be located in the animal or milk contact channel of a milking machine for sensing the pH in milk from the animals being milked.

In one embodiment, the signals are sent and/or received directly to and/or from the receiving module 610 as indicated by dashed line 622. In another embodiment, an external ear tag 624 or an internal ear tag 626 may include a transceiver and a power supply. Internal ear tags may include those manufactured by Fort Supply Livestock of Kaysville, Utah. Thus, the ear tags 624, 626 may receive signals from the module 100, as indicated by dashed line 623. The ear tags 624, 626 may also receive programming instructions and relay them to the monitor 100. When receiving signals from the sensors in the monitor, the ear tags 624, 626 transmit them to the receiving module 610 or a hand held receiving device, as indicated by dashed line 628. The ear tags 624, 626 may also have memory with capacity for a relatively large amount of data. The memory and speed of the system may be sufficient to enable collection and transmission of data for the several physiological conditions described herein for thirty cattle or more every two seconds. Providing transmission power in the ear tag(s) 624, 626 reduces the power requirement for the bolus or monitor 100. Thus, the monitor power can easily last for the 60-90 days that an animal will spend in the feedlots before harvesting. Furthermore, the power in the monitor may be supplied for up to three years in some cases, and in other cases the power supply in the monitor 100 can last for nine to ten years.

The illustrated system provides physiological monitoring at a distance of up to 800 meters, enabling detection of disease or distress even prior to unloading livestock after shipment. In the embodiment that utilizes the ear tag transmitters, signals can be relayed to a location 25 miles or more away through cellular phone or other networks. Monitoring may be performed through continuous read-out, periodic transmission, electronic interrogation, or event-triggered transmission. In the latter instance a logic module may compare a current reading with a pre-set value for any of the physiological parameters being monitored. Values outside of designated limits may trigger transmission of a signal. In an alternative embodiment, the comparison may occur in the receiving module 610 or in the analysis and programming and module 612, after transmission of a continuous or periodic signal. Once again, detection of values outside a predetermined range may trigger an alarm signal.

Physical identification of the affected animal does not rely on an ear tag or other external marker alone, but can be accomplished through triangulation of an RFID signal. For example, one or more transmitter/receiver may be supported on posts at distinct locations for isolating a position of an animal carrying a particular monitor 100 in its reticulorumen by known telemetry methods. Thus, serious problems including bovine respiratory syndrome and bloat can be promptly treated, reducing animal mortality. Aberrations in temperature and pH can likewise be quickly detected, and the animals in which the temperature or pH is abnormal can be quickly identified and the problem investigated.

The schematic flow chart diagrams that follow are generally set forth as a logical flow diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

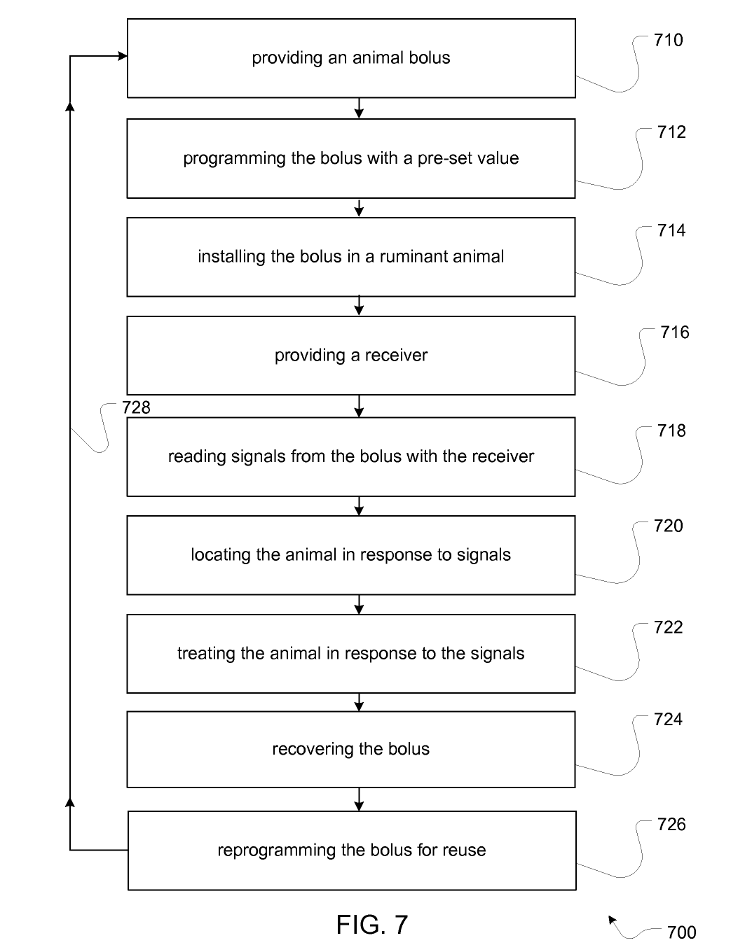

FIG. 7 is a schematic flow chart diagram illustrating one embodiment of a method 700 for monitoring an animal in accordance with the present invention. As depicted, the method 700 of monitoring includes the steps of providing an animal monitor 710 and programming the monitor with at least one pre-set value 712. The method 700 also includes installing the monitor in a ruminant animal 714. Another step is that of providing a receiver 716 and/or otherwise receiving one or more signal from the monitor. For example, the method may include reading the signals from the monitor with the receiver, as indicated at 718. Additional steps may include locating the animal in response to the signals 720 and/or treating the animal in response to the signals 722. The method 700 may include recovering the monitor 724. After recovering the monitor, the method may include the steps of reprogramming the monitor for reuse 726 and reusing the monitor 728.

The monitor provided according to one embodiment of the present invention includes a long barrel and a short cap removably attached to the long barrel with a moisture-tight seal therebetween. The cap may contain various sensing devices and the barrel may contain a weighted power source and a circuit board with various combinations of identification, location, and logic devices, a transmitter/receiver and the necessary electronics as known in the art in order to make the various devices function together properly. The long barrel may also contain a power source. The monitor may be configured to facilitate reprogramming for reuse either remotely such as while installed in an animal, or by a direct connection before or after removal from an animal.

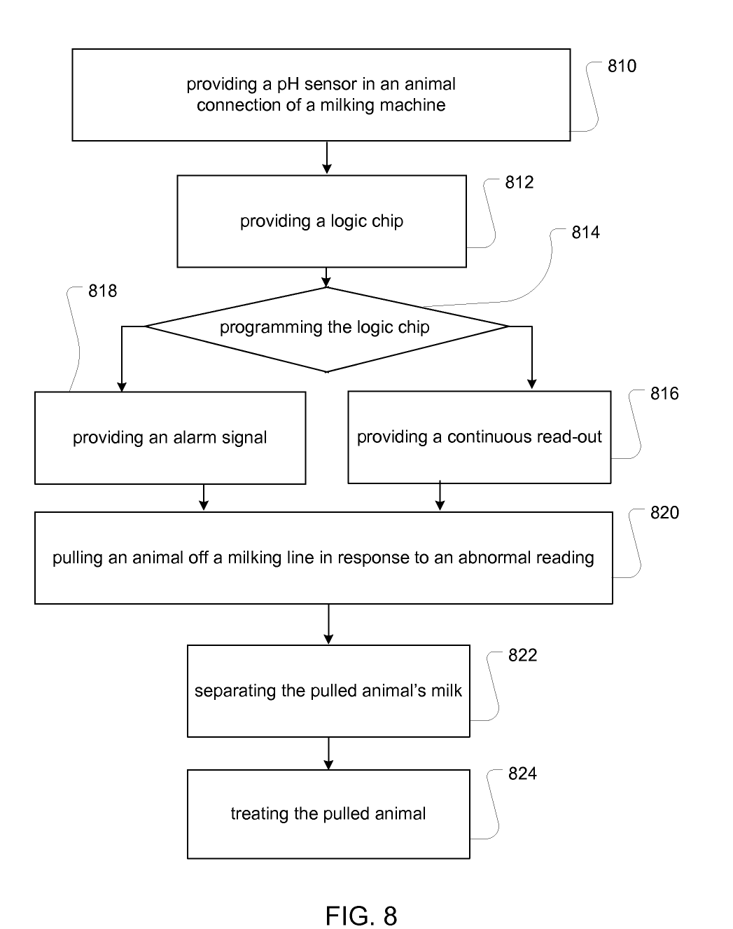

FIG. 8 is a schematic flow diagram illustrating one embodiment of a method 800 for sensing pH in an animal 800 in accordance with the present invention. As depicted, the method 800 for sensing pH includes providing a pH sensor on the animal connector of a milking machine 810. The method 800 also include one or more of providing a logic chip 812 and programming the logic chip 814. As shown in FIG. 8, the method may include notifying a user of an abnormal condition in the milk thus signaling an abnormal condition in the animal from which the milk was received. Notifying the user may be provided by optionally providing either an alarm signal 818 or a continuous read-out 816 at the user's discretion, for example. The method may also include pulling an animal from a milking line in response to an alarm signal and/or an abnormal reading 820. The method may also include one or more of separating the pulled animal's milk from a milk pool 822 and treating the pulled animal 824 in response to the alarm signal and/or the abnormal reading.

A slight variation in pH precedes the development of full-blown mastitis. Milk from an infected animal spoils very quickly, and one sick animal can contaminate the milk in the entire milk collection tank, diminishing the shelf life of all of the milk. Thus, it is advantageous to predict mastitis and keep the milk from the affected animal out of the collection tank. Treating the animal promptly reduces suffering and improves healing rates or times.

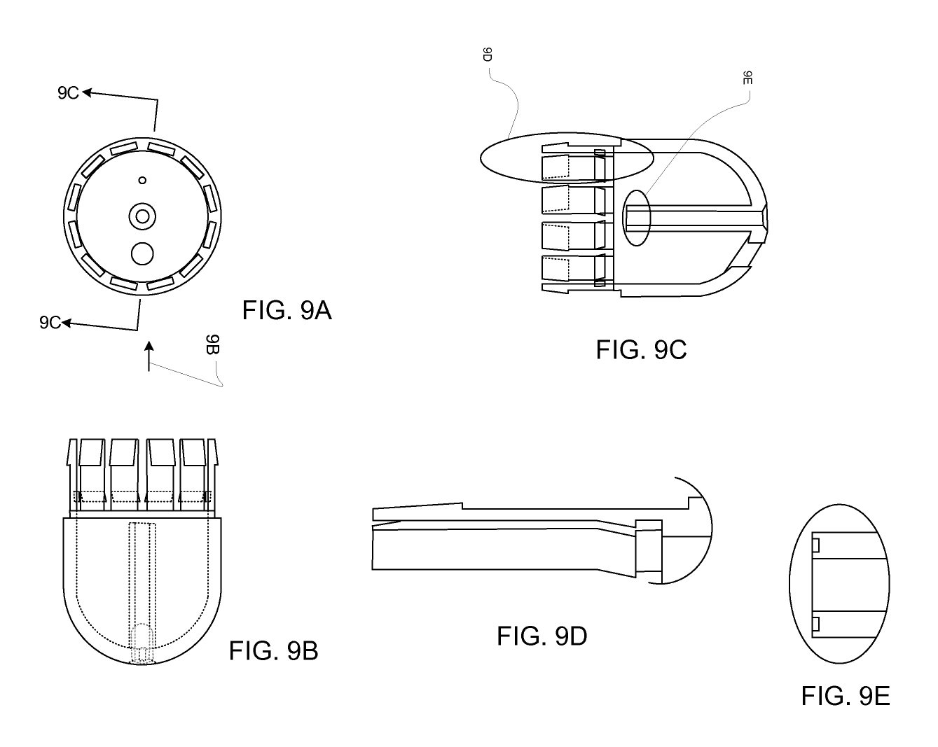

FIGS. 9A-9E are schematic and detailed views illustrating several features of embodiments of the invention for a cap 110. FIG. 9A is an end view of the cap 110 as viewed from an open end. The various labeled elements correspond to elements of like number described above. FIG. 9B is a side view taken in a direction of arrow 9B in FIG. 9A. FIG. 9C is a sectional view taken along line 9C-9C of FIG. 9A. FIG. 9D is a detailed view of a encircled region 9D of FIG. 9C. In this view, locking elements 910 and grooves 912 for receiving and holding the cap floor 212 to facilitate addition of the KCl and assembly during manufacture are provided on the locking flanges 114. FIG. 9E is a detailed view of an end of the tubular support sleeve 222 showing an end groove 914 for receiving an o-ring for sealing the tubular support sleeve 222 against the cap floor 212 similar to the sealing achieved by the o-ring 216 shown in FIG. 2. Thus, the various pieces fit together in a secure and sealed manner to protect the sensors and the electronics within the monitor 100.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A monitor of sufficient density to be retained in the reticulorumen of a ruminant animal, the monitor comprising;
a housing of non-ferrous, non-magnetic material and having a body comprising first and second portions;
the first portion supporting at least two physiological sensors including a pH sensor;
the second portion supporting electrical components including an identification module, an antenna, a transmitter, and a weighted power source;
at least one conducting surface on the first portion and at least one conducting surface on the second portion, the conducting surfaces configured to mutually interface when the first and second portions are joined together in a coupled configuration.

2. The monitor of claim 1, wherein the first portion is removably attached to the second portion with an attachment selected from the group consisting of a pressure fit, a screw fit, a snap cap and a friction seal.

3. The monitor of claim 1, wherein the pH sensor comprises an ion sensitive field effect transistor (ISFET).

4. The monitor of claim 1, wherein the first portion further comprises a temperature sensor.

5. The monitor of claim 1, wherein the first portion further comprises a pressure sensor.

6. The monitor of claim 1, wherein the first portion further comprises a position locator device.

7. The monitor of claim 1, wherein the position locator device comprises an RFID chip.

8. The monitor of claim 1, further comprising a signal receiver.

9. The monitor of claim 1, further comprising a logic chip configured to compare a sensor reading to a pre-programmed standard.

10. The monitor of claim 1, wherein:
the monitor is composed of non-ferrous, non-magnetic material and having a body including the first portion comprising a cap and the second portion comprising a barrel of a substantially longer length than the cap; and
the monitor body is of a cylindrical form with rounded ends

11. A system for monitoring the identity, location, and physiological condition of a ruminant animal, the system comprising:
a regurgitation-resistant, non-magnetic monitor having a first portion and a second portion;
the first portion comprising electronic and sensing components;
the electronic components comprising an identification device;
the sensing components comprising a pH sensor;
the second portion comprising a weighted power source;
the monitor further comprising a logic chip configured to compare a sensor reading to a pre-programmed standard;
the monitor further comprising a transmitter;
the system further comprising a receiver; and
the system further comprising a data recorder.

12. The system of claim 11, wherein the pH sensor is an ion sensitive field effect transistor (ISFET).

13. The system of claim 11, wherein the monitor further comprises a location device.

14. The system of claim 13, wherein the location device includes an RFID chip.

15. The system of claim 11, wherein the monitor further comprises a temperature sensor.

16. The system of claim 11, further comprising an additional pH sensor on an animal contact channel of a milking machine.

17. The system of claim 11, further comprising a user interface, the user interface comprising an alarm configured to generate an alert signal to communicate an abnormal reading by the sensors to the user through the user interface.

18. The system of claim 11, wherein the first portion comprises a short cap and the second portion comprises a long barrel such that the short cap comprises the electronic and sensing components and the long barrel comprises the weighted power source.

19. A method for monitoring the identity, location, and physiological condition of a ruminant animal, the method comprising:
providing a regurgitation-resistant, non-magnetic animal monitor configured to communicate animal identity and to sense and communicate at least one physiological condition including a pH of contents in the reticulorumen of an animal;
providing a receiver configured to recognize and interpret signals representing one or more of the identity and pH; and
reading the signals from the monitor with the receiver.

20. The method of claim 19, further comprising sensing the pH with an ion sensitive field effect transistor (ISFET).

21. The method of claim 19, further comprising locating the animal in response to signals from a location sensor in the monitor disposed in the reticulorumen.

22. The method of claim 21, wherein the location sensor is an RFID chip.

23. The method of claim 19, further comprising sensing temperature with a temperature sensor in the monitor disposed in the reticulorumen.

24. The method of claim 19, further comprising sensing pressure with a pressure sensor in the monitor disposed in the reticulorumen.

25. The method of claim 19, further comprising sensing a pH by a pH sensor on an animal contact of a milking machine.

26. The method of claim 19, further comprising providing a logic chip configured to compare a pH reading with a pre-programmed pH value, and comparing the pH reading with the pre-programmed pH value.

27. The method of claim 26, wherein the step of comparing comprises comparing by the logic chip in the monitor.

28. The method of claim 26, further comprising a preliminary step of pre-programming the logic chip.

29. The method of claim 19, further comprising sending an alarm signal to a user in response to an abnormal reading.

30. The method of claim 19, further comprising providing a continuous read-out of the pH sensor.

31. The method of claim 19, further comprising pulling an animal off of a milking line in response to an abnormal reading.

32. The method of claim 31, further comprising separating the pulled animal's milk from a pool of collected milk.

33. The method of claim 31, further comprising treating the pulled animal.

34. The method of claim 19, further comprising providing the monitor with a cap and a barrel of substantially greater length than the cap.

35. The method of claim 19, further comprising installing the monitor in a ruminant animal.

36. The method of claim 19, further comprising:
recovering the monitor upon harvesting of the animal; and
reprogramming the monitor for reuse.
